(19) United States
(12) Patent Application Publication
(10) Pub. No.: US 2015/0009687 A1
(43) Pub. Date: Jan. 8, 2015

(54) STRUCTURE FOR GUIDING LIGHT INTO GUIDE LIGHT PLATE TO CONDUCT TOTAL INTERNAL REFLECTION

(71) Applicant: Era Optoelectronics Inc., New Taipei City (TW)

(72) Inventor: Chih-Hsiung LIN, New Taipei City (TW)

(21) Appl. No.: 14/318,608

(22) Filed: Jun. 28, 2014

(30) Foreign Application Priority Data
Jul. 4, 2013 (TW) 102123951

(51) Int. Cl. F21V 8/00

(52) U.S. Cl. CPC G02B 6/0031
USPC 362/343

(57) ABSTRACT

A structure for guiding light into a light guide plate to conduct total internal reflection comprises a guide light plate and a prism; the prism is integrated with the guide light plate or joined to the guide light plate with an optical adhesive layer; the horizontal surface of the prism is parallel to the upper and lower surfaces of the guide light plate; the maximum angle between the horizontal surface and the slant surface of the prism is only 20 degrees to reduce the thickness of the prism greatly to meet requirements of lightness, thinness, shortness, and smallness for the electronic product; due to a special configuration of the prism and a special arrangement between the guide light plate and the prism, the most part of the light shot to the prism by the light source with any projecting angle is guided into the guide light plate to propagate the total internal reflection such that the light has an intensity capable of being sensed.

### CROSS-REFERENCE TO RELATED APPLICATIONS

The application claims priority from Taiwan Patent Application No. 102123951 filed on Jul. 4, 2013, the disclosure of which is incorporated herein by reference.

### BACKGROUND OF THE INVENTION

1. Field of the Invention

The present invention relates to a touch device with a guide light plate, and, more particularly, to a structure for guiding light into a guide light plate to conduct total internal reflection.

2. Description of Related Art

Many touch devices are employed to join with guide light plates. For instance, U.S. Pat. No. 7,432,893B2 which discloses an input device based on frustrated total internal reflection in which lights emitting from two or more light sources are shot into a transparent plate to conduct total internal reflection and sensed by a light sensing array which is disposed opposite to the light sources and surround the peripheral side of the transparent; when an object touches the surface of the transparent plate, the total internal reflection of the lights in the guide light plate are frustrated, and every touch causes that the sensed signals of two or more lights propagating in the transparent plate attenuate to allow subsequent process capable of determining the touch position and touch area.

The lights emitting from the light sources taught in U.S. Pat. No. 7,432,893B2 have to be aided with a prism to shoot into the transparent plate with a specific angle in order to conduct the total internal reflective propagation in the transparent plate; to adjust the specific angle needs a lot of man hours, and, under the circumferences, the projecting angle of the lights from the light sources is limited strictly as well.

Further, US Patent Application Publication No. 20130021302 discloses an optical coupler for use in an optical touch sensitive device in which the optical coupler is employed to join with the guide light plate for the light source and the sensor capable of being disposed in any directions with respect to the guide light plate.

But various types of optical couplers taught in US Patent Publication No. 20130021302 are huge in sizes which increase the weight and volume of the electronic product such that it is incapable of meeting requirements of lightness, thinness, shortness and smallness for the electronic product; in addition, the angle with which the light source shoots the light into the optical coupler is restricted as well, that is, it is incapable for the light to shoot into the optical coupler with any angle in order to be guided into the guide light plate by the coupler to perform the total internal reflective propagation.

### SUMMARY OF THE INVENTION

In order to improve the conventional structure for guiding the light into the guide light plate to perform the total internal reflection, the present invention is proposed.

The primary object of the present invention is to provide a structure for guiding light into a light guide plate to conduct total internal reflection in which a special configuration of the prism and a special arrangement between the guide light plate and the prism allow most of the light shot to the prism by the light source with any projecting angle and guided into the guide light plate to propagate the total internal reflection has an intensity capable of being sensed even if the light source provides low efficiency; moreover, it is not necessary to spend a lot of time and labors to adjust the angle of the light projecting the prism.

Another object of the present invention is to provide a structure for guiding light into a light guide plate to conduct total internal reflection in which the maximum angle between the horizontal surface and the slant surface of the prism is only 20 degrees to reduce the thickness of the prism greatly such that the prism has a small size to meet requirements of lightness, thinness, shortness, and smallness for the electronic product.

A structure for guiding light into a light guide plate to conduct total internal reflection according to the present invention comprises a guide light plate having an upper surface and a lower surface being parallel with each other, a prism having a horizontal surface, a vertical surface, a slant surface, and two opposite side surfaces, wherein the horizontal surface has two ends connecting with the vertical surface and the slant surface, respectively, the horizontal surface is perpendicular to the vertical surface, there is an angle between the horizontal surface and the slant surface, and the angle is between 10 to 20 degrees.

Wherein the prism is integrated with the guide light plate or joined to the guide light plate with an optical adhesive layer; the horizontal surface of the prism is parallel to the upper and lower surfaces of the guide light plate such that the light emitted by the light source passes through the vertical surface to shoot into the guide light plate via the upper surface directly or via the upper surface after being reflected by the slant surface, and then propagates in the guide light plate between said upper and lower surfaces to conduct total internal reflection; even if part of the light is incapable of propagating in the guide light plate to conduct the total internal reflection, it is shot into the prism via the guide light plate, reflected by said slant surface, and guided into the guide light plate again to propagate the total internal reflection.

Further benefits and advantages of the present invention will become apparent after a careful reading of the detailed description with appropriate reference to the accompanying drawings.

### BRIEF DESCRIPTION OF THE DRAWINGS

FIG. 1 is a plan view illustrating a structure for guiding light into a light guide plate to conduct total internal reflection in accordance with the present invention.

FIG. 2 is a perspective view of a prism disposed in the structure for guiding light into a light guide plate to conduct total internal reflection in accordance with the present invention.

### DETAILED DESCRIPTION OF THE INVENTION

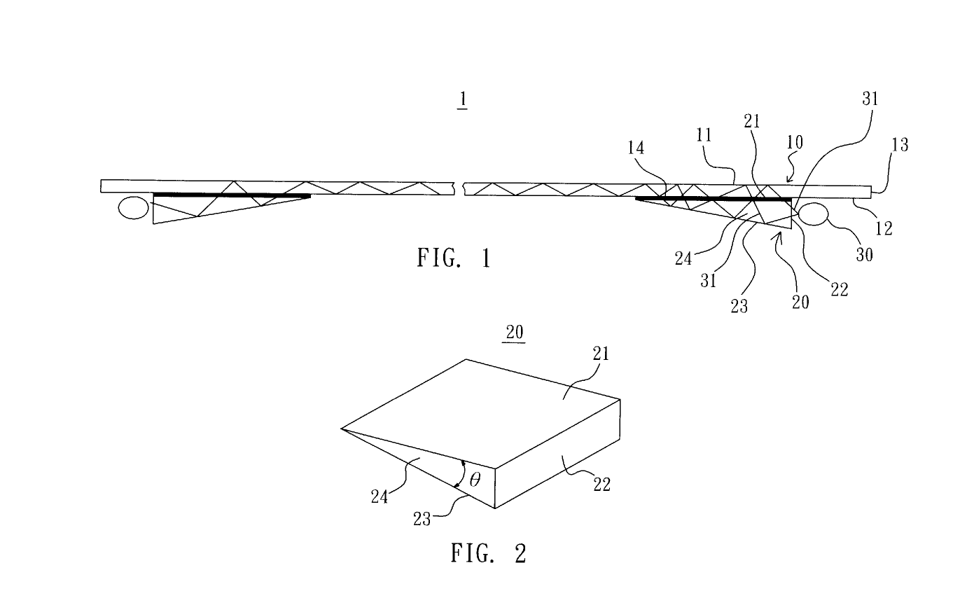

Referring to FIG. 1, a structure 1 for light guided into a light guide plate to conduct total internal reflection in accordance with the present invention comprises a guide light plate 10 and a prism 20.

The guide light plate 10 has an upper surface 11 and a lower surface 12 which are parallel with each other, and a peripheral surface 13 is formed by lateral edges of the guide light plate 10. The guide light plate 10 is made of guide light material such as acrylic, resin or glass in a form of bendable or unbendable plate.

The prism 20 has a horizontal surface 21, a vertical surface 22, a slant surface 23, and two opposite side surfaces 24. The horizontal surface 21 has two ends connecting with the vertical surface 22 and the slant surface 23, respectively. The two side surfaces 24 connect with the horizontal surface 21, the vertical service 22, and the slant surface 23, respectively. The horizontal surface 21 is perpendicular to the vertical surface 22. An angle θ between the horizontal surface 21 and the slant surface 23 is between 10 to 20 degrees approximately; it is preferable that the angle is 15 degrees.

The horizontal surface 21 of the prism 20 is parallel to the upper and lower surfaces 11, 12 of the guide light plate 10; the prism 21 can be integrated with the guide light plate 10 with the horizontal surface 21 of the prism 20 is joined to the upper surface 11 or the lower surface 12 of the guide light plate 10. Alternatively, the prism 20 can be disposed above the upper surface 11 or under the lower surface 12 of the guide light plate 10 with the horizontal surface 21 of the prism 20 adhering to the upper surface 11 or the lower surface 12 of the guide light plate 10 via an optical adhesive layer 14; the optical adhesive layer 14, the guide light plate 10 and the prism 20 have an identical index of refraction.

The light source 30 is disposed beside or leans against the vertical surface 22 of the prism 20; a light 31 emitted by the light source 30 passes through the vertical surface 22 to shoot into the guide light plate 10 via the upper surface 11 directly or via the upper surface 11 after being reflected by the slant surface 23; then, the light 31 propagates in the guide light plate 10 between the upper and lower surfaces 11, 12 to conduct total internal reflection; even if part of the light 31 is incapable of propagating in the guide light plate 10 to conduct the total internal reflection, the part of the light 31 is shot into the prism 20 via the guide light plate 10. reflected by the slant surface 23, and guided into the guide light plate 10 again to propagate the total internal reflection.

Due to a special configuration of the prism 20 and a special arrangement between the guide light plate 10 and the prism 20, it allows most part of the light 31, which is shot to the prism 20 by the light source 30 with any projecting angle, is guided into the guide light plate 10 to perform total internal reflective propagation such that the light 31 conducting the total internal reflection in the guide light plate 10 can have an intensity capable of being sensed even if the light source provides low efficiency; furthermore, it is not necessary to spend a lot of time and labors to adjust the angle of the light 31 projecting the prism 20.

It is appreciated that the maximum angle between the horizontal surface 21 and the slant surface 23 of the prism 20 is about 20 degrees; therefore, the thickness of the prism 20 can be reduced greatly to make the prism 20 smaller in size to meet requirements of lightness, thinness, shortness, and smallness for the electronic product. Hence, the conventional structure for guiding the light into the guide light plate to conduct the total internal reflection can be improved effectively.

Although the invention has been described in relation to its preferred embodiment, it is to be understood that many other possible modifications and variations can be made without departing from the spirit and scope of the invention as hereinafter claimed.

What is claimed is:

1. A structure for guiding light into a light guide plate to conduct total internal reflection, comprising:
a guide light plate having an upper surface and a lower surface being parallel with each other;
a prism having a horizontal surface, a vertical surface, a slant surface, and two opposite side surfaces, wherein the horizontal surface has two ends connecting with the vertical surface and the slant surface, respectively, the horizontal surface is perpendicular to the vertical surface, there is an angle between the horizontal surface and the slant surface. and the angle is between 10 to 20 degrees;
wherein the prism is integrated with the guide light plate or joined to the guide light plate with an optical adhesive layer; said horizontal surface of the prism is parallel to the upper and lower surfaces of the guide light plate such that a light emitted by a light source passes through said vertical surface to shoot into the guide light plate via said upper surface directly or via said upper surface after being reflected by said slant surface, and then propagates in the guide light plate between said upper and lower surfaces to conduct total internal reflection; even if part of the light is incapable of propagating in the guide light plate to conduct the total internal reflection, said part of the light is shot into the prism via the guide light plate, reflected by said slant surface, and guided into the guide light plate again to propagate the total internal reflection.

2. The structure for guiding light into a light guide plate to conduct total internal reflection as defined in claim 1. wherein the angle between the horizontal surface and the slant surface is 15 degrees.

3. The structure for guiding light into a light guide plate to conduct total internal reflection as defined in claim 1, wherein the horizontal surface of the prism is attached to the upper surface or the lower surface of the guide light plate with the optical adhesive layer.

4. The structure for guiding light into a light guide plate to conduct total internal reflection as defined in claim 2, wherein the horizontal surface of the prism is attached to the upper surface or the lower surface of the guide light plate with the optical adhesive layer.

5. The structure for guiding light into a light guide plate to conduct total internal reflection as defined in claim 1, wherein the guide light plate is made of guide light material in a form of bendable or unbendable plate.

6. The structure for guiding light into a light guide plate to conduct total internal reflection as defined in claim 1, wherein the guide light plate is glass plate.

7. The structure for guiding light into a light guide plate to conduct total internal reflection as defined in claim 2, wherein the guide light plate is made of guide light material in a form of bendable or unbendable plate.

8. The structure for guiding light into a light guide plate to conduct total internal reflection as defined in claim 3, wherein the guide light plate is made of guide light material in a form of bendable or unbendable plate.

9. The structure for guiding light into a light guide plate to conduct total internal reflection as defined in claim 4, wherein the guide light plate is made of guide light material in a form of bendable or unbendable plate.

10. The structure for guiding light into a light guide plate to conduct total internal reflection as defined in claim 2, wherein the guide light plate is glass plate.

11. The structure for guiding light into a light guide plate to conduct total internal reflection as defined in claim 3, wherein the guide light plate is glass plate.

12. The structure for guiding light into a light guide plate to conduct total internal reflection as defined in claim 4, wherein the guide light plate is glass plate.
